(19) United States
(12) Patent Application Publication
(10) Pub. No.: US 2025/0375823 A1
(43) Pub. Date: Dec. 11, 2025

(54) DEVICE TO REMOVE PLUG FROM HOLE SAW BIT AND RELATED SYSTEMS AND METHODS

(71) Applicant: R Kooima Consulting, LLC, Sioux Falls, SD (US)

(72) Inventor: Roger D. Kooima, Sioux Falls, SD (US)

(21) Appl. No.: 19/233,729

(22) Filed: Jun. 10, 2025

Related U.S. Application Data
(60) Provisional application No. 63/658,347, filed on Jun. 10, 2024.

(51) Int. Cl. B23B 51/04

(52) U.S. Cl. CPC B23B 51/0453

(57) ABSTRACT

The embodiments herein generally relate to a device for the removal of a hole saw plug including a device body, an actuator, and at least two pins. In response to the drill operating in a clockwise direction, the actuator is configured to move the pins toward the cavity. In response to the drill operating in a counterclockwise direction, the actuator is configured to move the pins outward from the cavity and toward the hole saw such that the pins contact a plug disposed within the hole saw, thereby applying a force on the plug such that the plug can be removed from the hole saw.

### CROSS-REFERENCE TO RELATED APPLICATION(S)

This disclosure claims priority to U.S. provisional patent application 63/658,347, filed on Jun. 10, 2024, and entitled “Device to Remove Plug from Hole Saw Bit,” which is hereby incorporated herein by reference in its entirety.

### TECHNICAL FIELD

The disclosure relates to hole saw bits.

### BACKGROUND OF THE INVENTION

After drilling a hole using a hole saw, there can be a plug (or slug) lodged in the hole saw bit. The plug is generated when the hole saw cuts through a piece of material. This plug is typically retained in the hole saw bit after use of the hole saw is completed. Removing the plug can be difficult and time consuming.

The hole saw bits can have holes, slots, and/or other openings to accommodate screwdrivers, punches, or other various tools so the operator can pry the plug out of the hole. However, manipulation of the hole saw can be dangerous, as its edges can be sharp and the tool can become heated from use.

### SUMMARY OF THE INVENTION

In general, the disclosure is directed to a hole saw plug removal device that is configured to remove a plug from a hole saw bit. After use of the hole saw, the hole saw can become plugged with material. The embodiments described herein can be configured for use with any standard drill and hole saw. For example, the device can be configured to couple with a 5/8″×18 threaded hole saw bit, but in other applications, can be configured to accommodate other types of hole saw bits.

The embodiments and methods described herein can facilitate the removal of the plug from the hole saw. The device can be configured to apply a force on the plug of the hole saw, thereby dislodging the plug from the hole saw. This can reduce the time needed to remove the plug from the hole saw by directly applying an opposing force to the plug, thereby moving it. Additionally, the embodiments and methods described herein can increase the safety of a user when removing the plug. The device can reduce a user's need to manipulate the hole saw, which can become heated during use and is generally sharp.

One embodiment includes a device for the removal of a hole saw plug. The device comprises a device body, an actuator, and at least two pins. The device body, comprises a drill end configured to operably couple with a drill, a hole saw end configured to operably couple with a hole saw, and a wall extending from the drill end to the hole saw end and forming a cavity. The actuator is disposed within the cavity and operably coupleable to the drill. The at least two pins comprise a first end operably coupled to the actuator and a second end configured to protrude outwardly from the cavity and through the wall. The second end is configured to be disposed through a hole saw opening. In response to the drill operating in a clockwise direction, the actuator is configured to move the pins toward the cavity. In response to the drill operating in a counterclockwise direction, the actuator is configured to move the pins outward from the cavity and toward the hole saw such that the pins contact a plug disposed within the hole saw, thereby applying a force on the plug such that the plug is removable from the hole saw.

In a further embodiment, the device further comprises a lock disposed on the device body. The lock includes a locked configuration and an unlocked configuration. The unlocked configuration allows for a first amount of translational movement of the at least two pins during operation of the drill. The locked configuration allows for a second amount of translational movement of the at least two pins during operation of the drill, the second amount being less than the first amount.

In a further embodiment, the actuator comprises a rod configured to extend through the drill end, the rod being operably coupleable with the drill, a first clutch piece configured to receive the rod, and a second clutch piece configured to receive the rod. The second clutch piece being operably coupleable with the first clutch piece and operably coupled to the at least two pins. Movement of the lock from the locked configuration to the unlocked configuration causes the first clutch piece to uncouple from the second clutch piece. In a further embodiment, when the drill is operating in the clockwise direction while the lock is in the locked configuration, the first clutch piece is configured to operably engage the second clutch piece such that the device is configured to actuate the hole saw and the pins engage the hole saw.

In a further embodiment, when the drill is operating in the counterclockwise direction while the lock is in the unlocked configuration, the actuator is configured to translationally move the pins toward the hole saw.

In a further embodiment, when the drill is operating in the clockwise direction while the lock is in the unlocked configuration, the actuator is configured to translationally move the pins towards the cavity.

In a further embodiment, the device body is configured to move rotationally when the drill is operating in the clockwise direction while the lock is in the locked configuration, and the device body is capable of remaining rotationally stationary when the drill is operating while the lock is in the unlocked configuration.

Another embodiment includes a hole saw plug removal assembly comprising a drill, a hole saw, and a hole saw plug removal device. The hole saw plug removal device comprises a device body, an actuator, and at least two pins. The device body comprises a drill end configured to operably couple with the drill, a hole saw end configured to operably couple with the hole saw, a wall extending from the drill end to the hole saw end and forming a cavity. The actuator is disposed within the cavity and operably coupleable to the drill. The at least two pins comprise a first end operably coupled to the actuator and a second end configured to protrude outwardly from the cavity and through the wall, the second end being configured to be disposed through a hole saw opening. In response to the drill operating in a clockwise direction, the actuator is configured to move the pins into the cavity. In response to the drill operating in a counterclockwise direction, the actuator is configured to move the pins outward from the cavity and toward the hole saw such that the pins contact a plug disposed within the hole saw, thereby applying a force on the plug such that the plug is removable from the hole saw.

In a further embodiment, the assembly further comprises an arbor disposed at the hole saw end of the hole saw plug removal device configured to receive the pins therethrough, and wherein the pins are configured to sit flush with the arbor in response to the drill operating in the clockwise direction. In a further embodiment, the pins are configured to align with a plurality of openings through a surface of the hole saw and, in response to the drill operating in a counterclockwise direction, the pins are configured to pass through the plurality of openings.

In a further embodiment, the assembly further comprises a lock disposed on the device body, the lock comprising a locked configuration and an unlocked configuration. The lock is operably coupled to the at least two pins. The unlocked configuration allows for a first amount of translational movement of the at least two pins during operation of the drill. The locked configuration allows for a second amount of translational movement of the at least two pins during operation of the drill, the second amount being less than the first amount.

In a further embodiment, the actuator comprises a rod configured to extend through the drill end, the rod being operably coupleable with the drill, a first clutch piece configured to receive the rod, a second clutch piece configured to receive the rod, the second clutch piece being operably coupleable with the first clutch piece and operably coupled to the at least two pins, and a guide bar configured to guide the movement of the first clutch piece and the second clutch piece. Movement of the lock from the locked configuration to the unlocked configuration causes the first clutch piece to uncouple from the second clutch piece. The first clutch piece is configured to travel along the guide bar.

Another embodiment includes a method for removing a hole saw plug comprising providing an assembly for removing a hole saw plug, the assembly comprising a drill, a hole saw comprising a plurality of hole saw openings, and a hole saw plug removal device comprising a device body comprising a drill end configured operably coupled with the drill, a hole saw end configured to operably couple with the hole saw, and a wall extending from the drill end to the hole saw end and forming a cavity; an actuator disposed within the cavity and operably coupleable to the drill, at least two pins comprising a first end operably coupled to the actuator and a second end, and the method includes operating the drill in a counterclockwise direction such that the at least two pins move translationally through the hole saw openings, thereby applying a force on a plug such that the plug is removable from the hole saw.

In a further embodiment, the method further comprises operating the drill in a clockwise direction such that the pins retract toward the cavity.

In a further embodiment, the hole saw plug removal device further comprises a lock disposed on the device body, the lock comprising a locked configuration and an unlocked configuration and the lock is operably coupled to the at least two pins, the unlocked configuration allows for a first amount of translational movement of the at least two pins during operation of the drill, and the locked configuration allows for a second amount of translational movement of the at least two pins during operation of the drill, the second amount being less than the first amount. The method further comprises unlocking the lock prior to operating the drill in a counterclockwise direction, thereby allowing the at least two pins to move the first amount of translational movement during operation of the drill. In a further embodiment, the method further comprises unlocking the lock and, after unlocking the lock, operating the drill in a clockwise direction such that the pins retract toward the cavity. In a further embodiment, the method further comprises locking the lock after locking the lock, operating the hole saw in a clockwise direction.

In a further embodiment, the method further comprises immobilizing the device body during operation of the drill, thereby preventing actuation of the hole saw and causing the translational movement of the pins.

In a further embodiment, the method further comprises aligning the pins with the hole saw openings.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a perspective view of an example assembly including a hole saw plug removal device in accordance with one or more examples of this disclosure.

FIG. 2 is a close-up perspective view of an example hole saw plug removal device in accordance with one or more examples of this disclosure.

FIG. 3 is a perspective view of an example hole saw plug removal device in accordance with one or more examples of this disclosure.

FIG. 4A is a perspective view of an example hole saw plug removal device in accordance with one or more examples of this disclosure.

FIG. 4B perspective view of an example hole saw plug removal device in accordance with one or more examples of this disclosure.

FIG. 5 is top transparent view of an example hole saw plug removal device in accordance with one or more examples of this disclosure.

FIG. 6 is an expanded view of an example hole saw plug removal device in accordance with one or more examples of this disclosure.

FIG. 7 is an expanded view of an example hole saw plug removal device in accordance with one or more examples of this disclosure.

FIG. 8 is a flow diagram of a method of use of an example hole saw plug removal device in accordance with one or more examples of this disclosure.

FIG. 9 is a flow diagram of a method of installation of an example hole saw plug removal device in an assembly in accordance with one or more examples of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein.

Those skilled in the art will recognize that many of the noted examples have a variety of suitable alternatives.

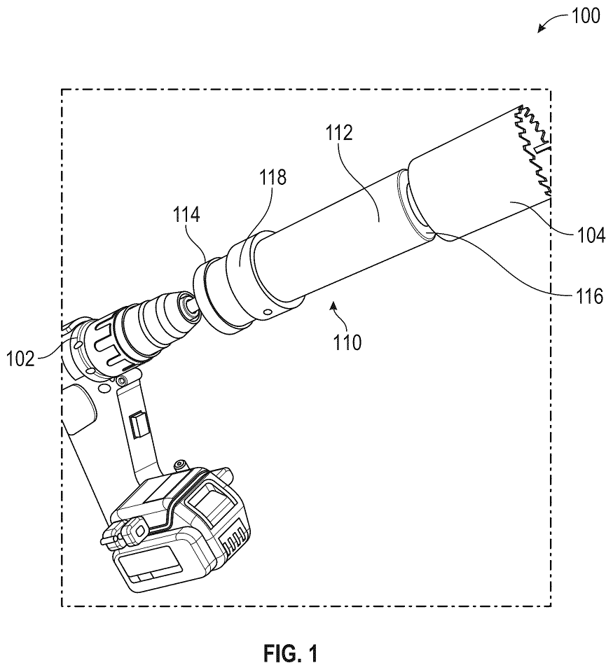

FIG. 1 is a perspective view of an illustrative assembly 100 including a drill 102, a hole saw 104, and a hole saw plug removal device 110. The embodiments herein generally relate to a device 110 for the removal of a hole saw plug (not pictured) including a device body 112, an actuator 117 disposed within the device body 112, and at least two pins 120A, 120B. During use, the actuator 117 is configured to move the pins 120A, 120B such that the pins 120A, 120B apply a force on the plug such that the plug can be removed from the hole saw 104.

The device 110 can include a variety of structural features. For example, the device body 112 includes a drill end 114 configured to operably couple with a drill 102, a hole saw end 116 configured to operably couple with a hole saw 104, and a wall 113 extending from the drill end 114 to the hole saw end 116 and forming a cavity 115. The actuator 117 can be disposed within the cavity 115 and can be operably coupleable to the drill 102.

The operation of the drill 102 can determine the direction of the translational movement of the pins 120A, 120B. In response to the drill 102 operating in a clockwise direction, the actuator 117 is configured to move the pins 120A, 120B toward, or into, the cavity 115. In response to the drill 102 operating in a counterclockwise direction, the actuator 117 is configured to move the pins 120A, 120B outward from the cavity 115 and toward the hole saw 104 such that the pins 120A, 120B contact a plug disposed within the hole saw 104, thereby applying a force on the plug. Said force can “pop” out the plug from its position within the hole saw 104, making it easier and safer to remove the plug.

The pins 120A, 120B can be disposed in various configurations. For example, the pins can be in a retracted configuration or an extended configuration. Translational movement of the pins 120A, 120B can change the pins 120A, 120B from the retracted configuration to the extended configuration.

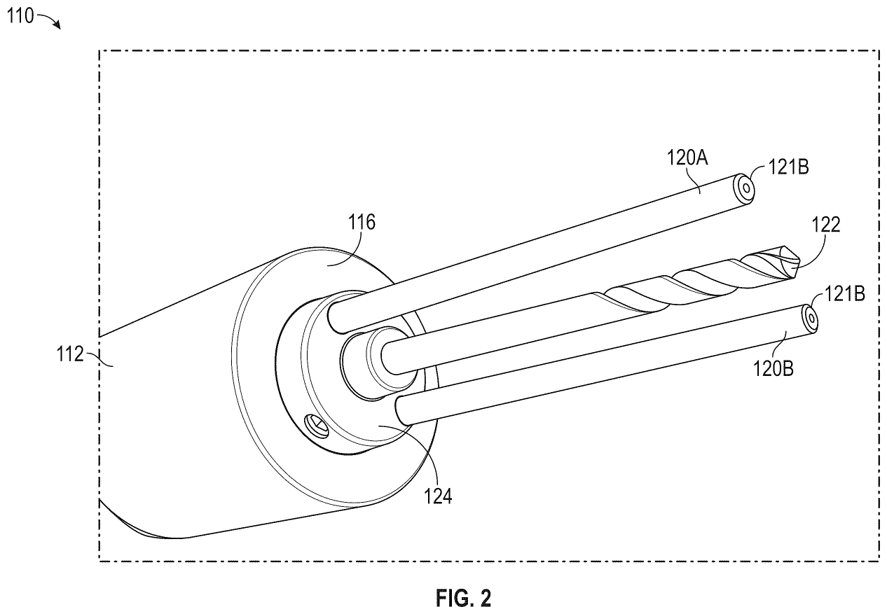

FIG. 2 shows the pins 120A, 120B of the device in an extended configuration. The at least two pins 120A, 120B can include a first end 121A operably coupled to the actuator 117, and a second end 121B configured to protrude outwardly from the cavity 115 and through the wall 113. The second end 121B can be configured to be disposed through a hole saw opening (not pictured) when in the extended configuration shown in FIG. 2.

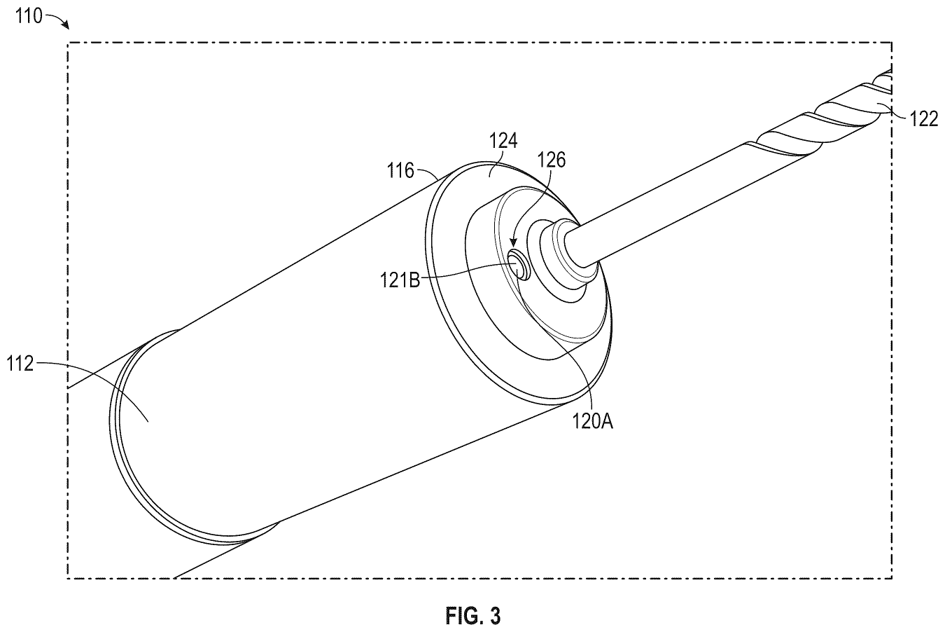

FIG. 3 shows the pins 120A, 120B in a retracted configuration. When the pins 120A, 120B are in a retracted configuration, the pins 120A, 120B can be disposed through and/or in various structural features of the device 110. For example, in some embodiments, the device 110 includes an arbor 124 disposed at the hole saw end 116 of the hole saw plug removal device 110. The arbor 124 is configured to receive the pins 120A, 120B therethrough and receive a pilot drill bit 122. The pilot drill bit 122 can be any pilot drill bit. In some applications, the pilot drill bit 122 can have a ⅝-18 in. thread. The pins 120A, 120B are configured to sit flush with the arbor 124 in response to the drill 102 operating in the clockwise direction.

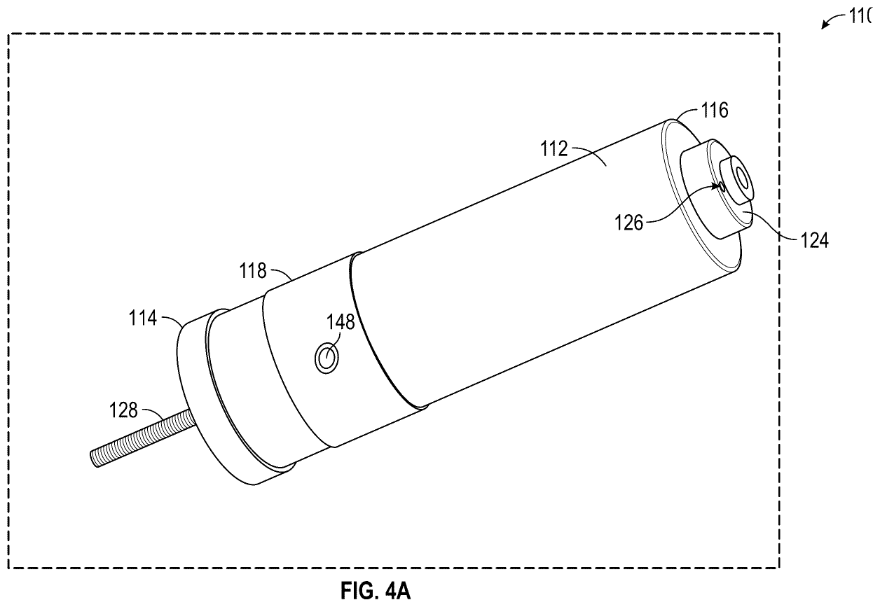

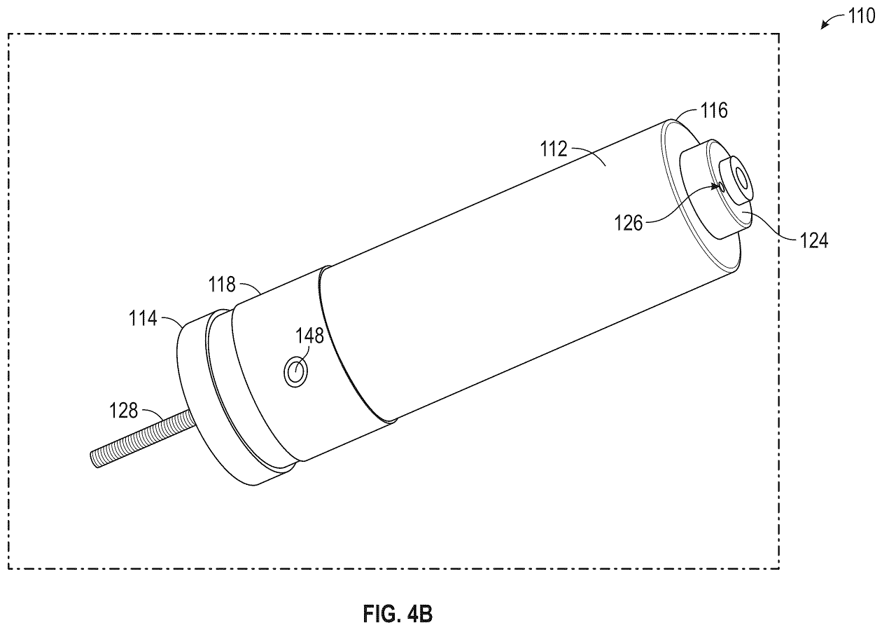

Movement of the pins 120A, 120B between the extended configuration and the retracted configuration can be primarily controlled by the drill 102, however, additional components can control the pins 120A, 120B. In some embodiments, the device 110 can include a lock 118. The lock 118 can be disposed on the device body 112. The lock 118 can be operably coupled to the at least two pins 120A, 120B. In some illustrative embodiments, the lock 118 can be a ring disposed around the body 112 of the device 110, as shown in FIG. 4A and FIG. 4B.

The lock 118 can have a locked configuration and an unlocked configuration. The locked configuration can prevent at least some translational movement of the at least two pins 120A, 120B during operation of the drill 102 such that the at least two pins 120A, 120B do not fully retract into the cavity 112. The unlocked configuration can allow for increased translational movement of the at least two pins 120A, 120B during operation of the drill 102 when compared to the translational movement the pins 120A, 120B of the locked configuration. FIG. 4A and FIG. 4B each show the locked and unlocked configuration, respectively. When the lock 118 is in the locked configuration, the lock 118 can be closer to the hole saw end 116 of the device 110 than when the lock 118 is in the unlocked configuration. That is, when the lock 118 is in the unlocked configuration, the lock 118 can be closer to the drill end 114 of the device 110.

When the lock 118 is in the locked configuration, the pins 120A, 120B may be able to move translationally; however, the range of translational movement may be less than the possible translational movement of the pins 120A, 120B when the lock 118 is in the unlocked configuration. For example, the translational movement of the pins 120A, 120B such that the pins 120A, 120B are flush with the arbor 124 may be prevented by the locked position of the first clutch piece 134. That is, the pins 120A, 120B may protrude from the arbor 124 when the lock 118 is in the locked position. The protrusion may be about ¼ inch to about 5/16 inch from the arbor 124. When the pins 120A, 120B protrude from the arbor 124, each of the pins 120A, 120B may engage with an opening in the hole saw 104.

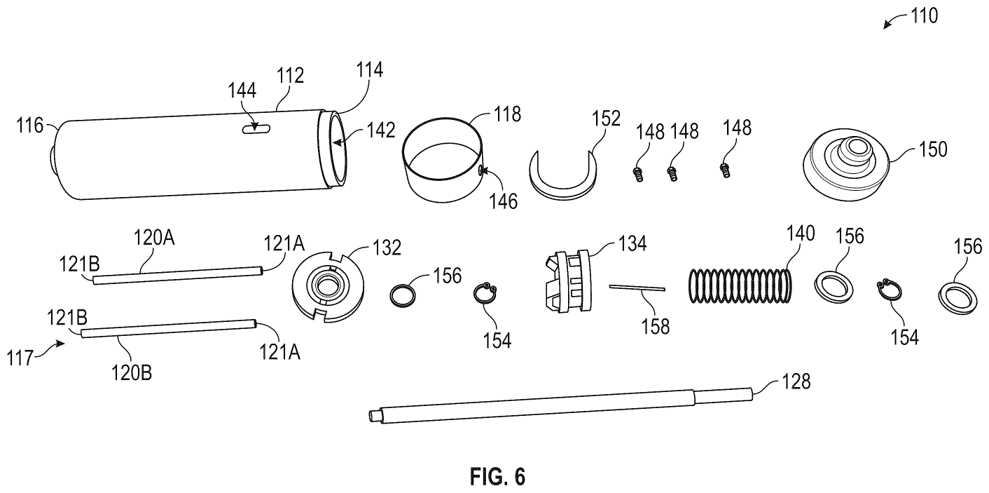

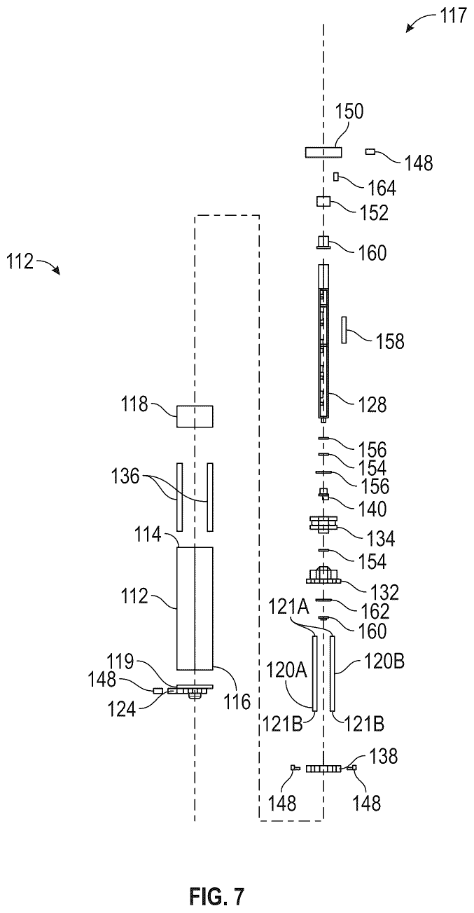

The lock 118 can be operably coupled to the actuator 117 of the device 110. The device body 112 can be configured to receive a moveable coupling mechanism (e.g., a mechanical fastener) therethrough, allowing a user to change of the lock 118 from its locked configuration to its unlocked configuration. For example, the device body 112 can include a slot 144 (shown in FIG. 6) configured to receive the coupling mechanism (e.g., a fastener such as fastener 148 of FIG. 6-7). The coupling mechanism can move within the slot 144.

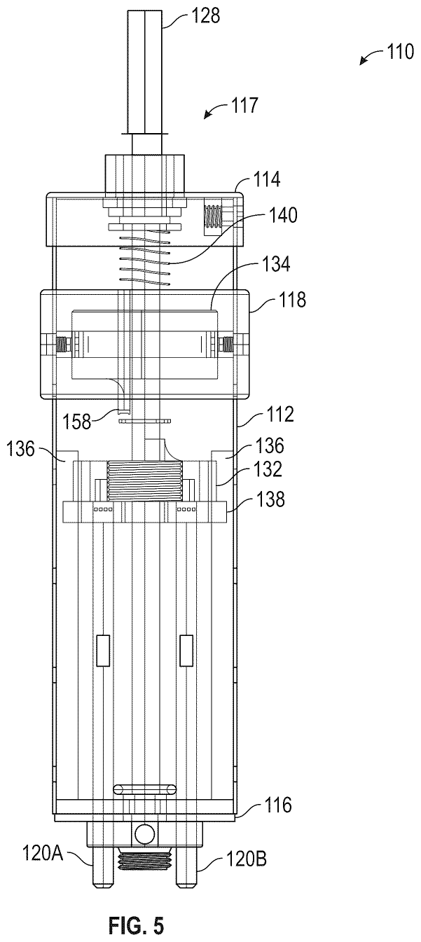

The lock configuration can determine the operation of the actuator 117. FIG. 5 shows the actuator 117 when the actuator 117 is disposed within the device body 112. In some embodiments, the actuator 117 can include a rod 128, a first clutch piece 134, and a second clutch piece 132 (while the embodiments described herein use one clutch configuration, any clutch configuration may be used with the embodiments described herein). The rod 128 can be configured to extend through the drill end 114 and can be operably coupleable with the drill 102. The first clutch piece 134 can be configured to receive the rod 128. The second clutch piece 132 can be configured to receive the rod 128. The second clutch piece 132 can be operably coupleable with the first clutch piece 134 and operably coupled to the at least two pins 120A, 120B (e.g., threadably connected). The first and second clutch pieces 134, 132 can be any known clutch and may include additional components (e.g., a shift fork and structures configured to receive the shift fork) used in combination with known clutches.

The actuator 117 can include additional components and be configured in a variety of ways. For example, in some embodiments, the rod 128 can be threadably mated to the second clutch piece 132 and not be threadably mated to the first clutch piece 134, allowing the first clutch piece 134 to move over the rod 128. In other embodiments, the rod 128 may be operably coupled to the second clutch piece 132 using different means. In yet another illustrative embodiment, the threaded rod 128 may directly drive the pins 120A, 120B to push the plug out of the hole saw 104.

The device body 112 can house components configured to orient the actuator 117 within the body 112. In some embodiments, guide bars 136 can be configured to guide the movement of the first clutch piece 134 and the second clutch piece 132. Some embodiments can include one or multiple guide bars 136. Movement of the lock 118 from the locked configuration to the unlocked configuration causes the first clutch piece 134 to uncouple from the second clutch piece 132. Said uncoupling can result in movement of the first clutch piece 134. During said movement, the first clutch piece 134 is configured to travel along the guide bars 136 and can include a keyway configured to receive a square key 158. The keyway can be machined into the first clutch piece 134.

Additional components, shown in FIG. 6 and FIG. 7 (collectively discussed herein) can be included in the device. For example, fasteners 148, nuts 164, bearings and/or bushings 152, washers 156, rings 154, bumper(s) 162, spring 140, and/or other mechanical components may be included in the device. Some rings 154 may be retaining rings and/or snap rings. In other illustrative examples, instead of retaining rings and/or snap rings, collars may be used. This can include, but is not limited to, collars with set screws, collars with cross pins, collars brazed and/or welded to the shaft, and/or machined collars. It is to be understood that FIG. 6 shows the external and internal components of the device. FIG. 6 shows an upper row showing an expanded view of the external components of the device and a lower row showing, from left to right, an expanded view of the internal components of the device 110 and how they may fit together. FIG. 7 shows another illustrative example of how these components may be oriented relative to one another.

When assembling the device 110, the components can generally be inserted into the device 110 from the hole saw end 116 to the drill end 114. First, pins 120A, 120B can be inserted, then retaining rings 154, a square key 158, a compression spring 140, washer(s) 156, a bumper, and shift fork 138 can be guided into cavity 142. The pins 120A, 120B can be aligned with and extend through the openings 126 in the arbor 124. A cap 150 can be attached to the device body 112. The cap 150 may be attached using a mechanical fastener 148.

The configuration of first clutch piece 134 and second clutch piece 132 can determine the movement of the actuator 117. For example, movement of the lock 118 from the locked configuration to the unlocked configuration can cause the first clutch piece 134 to uncouple from the second clutch piece 132. In some embodiments, when the drill 102 is operating in the counterclockwise direction while the lock 118 is in the unlocked configuration, the actuator 117 is configured to translationally move the pins 120A, 120B toward the hole saw 104. The pins 120A, 120B can be configured to align with a plurality of openings through a surface of the hole saw 104. In response to the drill 102 operating in a counterclockwise direction, the pins 120A, 120B are configured to pass through the plurality of openings. When the pins 120A, 120B are positioned within the hole saw 104, the lock 118 can be positioned in its locked configuration such that the pins 120A, 120B remain positioned in the hole saw 104.

The unlocked configuration can also allow for translational of the pins 120A, 120B away from the hole saw 104. In some embodiments, when the drill 102 is operating in the clockwise direction while the lock 118 is in the unlocked configuration, the actuator 117 is configured to translationally move the pins 120A, 120B towards the cavity 115.

When the first clutch piece 134 and the second clutch piece 132 are operably coupled, the hole saw 104 may be used. That is, in some embodiments, when the drill 102 is operating in the clockwise direction while the lock 118 is in the locked configuration, the first clutch piece 134 is configured to operably engage the second clutch piece 132 such that the device 110 is configured to actuate the hole saw 104. The first clutch piece 134 may rotate freely when operably coupled to the lock 118.

In some embodiments, the device body 112 can be configured to move rotationally when the drill 102 is operating in the clockwise direction while the lock 118 is in the locked configuration. Additionally or alternatively, the device body 112 is capable of remaining rotationally stationary when the drill 102 is operating while the lock 118 is in the unlocked configuration. The device 110 may include a structure or mechanism that prevents rotational movement; however, in other embodiments, a user may hold the device body 112, thereby preventing rotational movement of the device body 112. Preventing rotation of the device body 112 while the first and second clutch pieces 134, 132 are not operably connected, can cause the rod 128 to move the first clutch piece 134 toward the drill end 114 of the device body 112 such that the pins 120A, 120B retract into the cavity 115. Similarly, while in the unlocked configuration, counterclockwise operation of the drill 102 will move the pins 120A, 120B toward the hole saw 104. More specifically, the movement of the first clutch piece 134 can cause the first clutch piece 134 to engage and/or disengage with the second clutch piece 132, which can limit the translational movement of the pins 120A, 120B.

Preventing rotational movement of the device body 112 prevents rotational movement of the second clutch piece 132, thereby causing it to move translationally such that rotational forces are transferred to the guide bars 136, device body 112, and hole saw 104.

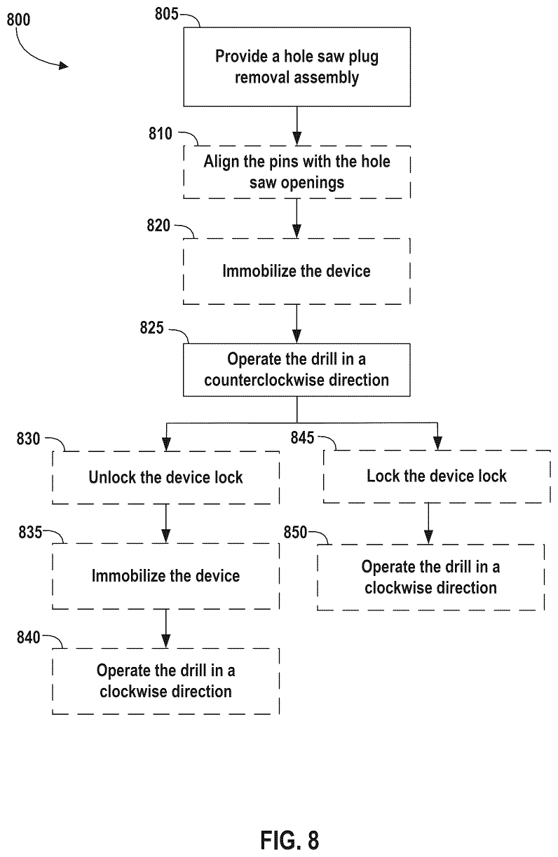

FIG. 8 shows a method 800 of use of the assembly. The method 800 includes providing an assembly for removing a hole saw plug (805), such as the illustrative embodiments for the assembly described herein. The method includes operating the drill in a counterclockwise direction such that the at least two pins move translationally through the hole saw openings, thereby applying a force on a plug such that the plug is removable from the hole saw (825). In some applications, the method can include operating the drill such that the drill chuck turns about 2-3 times. Some embodiments of the method include aligning the pins with the hole saw openings (810). This can allow the pins to pass therethrough and may be completed prior to operating the drill.

The illustrative methods described herein may be used with devices having a lock, such as those of FIG. 4A-4B. Some embodiments of the method can further include unlocking the lock and (830), after locking the lock, operating the drill in a clockwise direction such that the pins retract toward the cavity (840). Some embodiments of the method include immobilizing the device body during operation of the drill, thereby preventing actuation of the hole saw and causing the translational movement of the pins (835). Unlocking the lock and operating the drill in a clockwise direction can allow a user to remove the hole saw bit and/or attach another hole saw bit to the device.

This movement causes the pins to exert a force onto the plug. This force relies on the torque of the device rod to apply the force on the plug. This results in a relatively brief movement of the pins, which can cause relatively quick disengagement of the plug from the hole saw because the pins move through the hole saw and push the plug out of the hole saw. In some applications, the plug may be completely pushed out of the hole saw by the force applied by the pins. Because the device can be used with a variety of drills and/or hole saws, the device can be used in a variety of applications and settings. The device can be made with various materials, such as metal (which may be machined), and the device body and actuator components can have different diameters, lengths, and/or structural characteristics. Additionally or alternatively, the method can include locking the lock (845) and, after locking the lock, operating the hole saw (850). When the lock is in a locked configuration, the pins may not retract entirely into the cavity; the pins may still protrude from the device body.

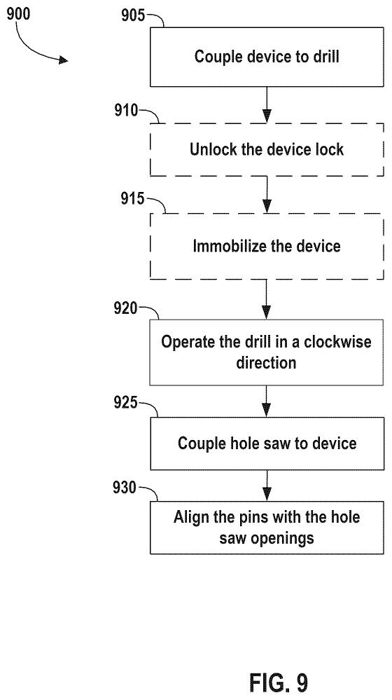

FIG. 9 shows a method 900 of installation of an embodiment of a device described herein. To attach the device to a drill, the device can be coupled to the drill (900). The method can include operating the drill in a clockwise direction such that the pins retract toward the cavity (920). This can include unlocking the lock (910) such that the pins retract entirety into the cavity and/or immobilizing the device (920) such that the device body does not rotate during operation of the drill. The method can include coupling a hole saw to the device (925). The method can include aligning the pins with the hole saw openings (930).

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wavelength, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

What is claimed is:

1. A device for the removal of a hole saw plug, comprising:
a device body, comprising:
a drill end configured to operably couple with a drill;
a hole saw end configured to operably couple with a hole saw;
a wall extending from the drill end to the hole saw end and forming a cavity;
an actuator disposed within the cavity and operably coupleable to the drill; and
at least two pins comprising:
a first end operably coupled to the actuator; and
a second end configured to protrude outwardly from the cavity and through the wall, the second end being configured to be disposed through a hole saw opening;
wherein:
in response to the drill operating in a clockwise direction, the actuator is configured to move the pins toward the cavity; and
in response to the drill operating in a counterclockwise direction, the actuator is configured to move the pins outward from the cavity and toward the hole saw such that the pins contact a plug disposed within the hole saw, thereby applying a force on the plug such that the plug is removable from the hole saw.

2. The device of claim 1, further comprising a lock disposed on the device body,
the lock having a locked configuration and an unlocked configuration; wherein:
the lock is operably coupled to the at least two pins;
the unlocked configuration allows for a first amount of translational movement of the at least two pins during operation of the drill; and
the locked configuration allows for a second amount of translational movement of the at least two pins during operation of the drill, the second amount being less than the first amount.

3. The device of claim 2, wherein:
the actuator comprises:
a rod configured to extend through the drill end, the rod being operably coupleable with the drill;
a first clutch piece configured to receive the rod; and
a second clutch piece configured to receive the rod, the second clutch piece being operably coupleable with the first clutch piece and operably coupled to the at least two pins, and wherein movement of the lock from the locked configuration to the unlocked configuration causes the first clutch piece to uncouple from the second clutch piece.

4. The device of claim 3, wherein, when the drill is operating in the clockwise direction while the lock is in the locked configuration, the first clutch piece is configured to operably engage the second clutch piece such that the device is configured to actuate the hole saw and the pins engage the hole saw.

5. The device of claim 2, wherein, when the drill is operating in the counterclockwise direction while the lock is in the unlocked configuration, the actuator is configured to translationally move the pins toward the hole saw.

6. The device of claim 2, wherein, when the drill is operating in the clockwise direction while the lock is in the unlocked configuration, the actuator is configured to translationally move the pins towards the cavity.

7. The device of claim 2, wherein:
the device body is configured to move rotationally when the drill is operating in the clockwise direction while the lock is in the locked configuration; and
the device body is capable of remaining rotationally stationary when the drill is operating while the lock is in the unlocked configuration.

8. A hole saw plug removal assembly, comprising:
a drill;
a hole saw;
a hole saw plug removal device, comprising:
a device body, comprising:
a drill end configured to operably couple with the drill;
a hole saw end configured to operably couple with the hole saw;
a wall extending from the drill end to the hole saw end and forming a cavity;
an actuator disposed within the cavity and operably coupleable to the drill; and
at least two pins comprising:
a first end operably coupled to the actuator; and
a second end configured to protrude outwardly from the cavity and through the wall, the second end being configured to be disposed through a hole saw opening; and
wherein:
in response to the drill operating in a clockwise direction, the actuator is configured to move the pins into the cavity; and
in response to the drill operating in a counterclockwise direction, the actuator is configured to move the pins outward from the cavity and toward the hole saw such that the pins contact a plug disposed within the hole saw, thereby applying a force on the plug such that the plug is removable from the hole saw.

9. The hole saw plug removal assembly of claim 8, further comprising an arbor disposed at the hole saw end of the hole saw plug removal device configured to receive the pins therethrough, and wherein the pins are configured to sit flush with the arbor in response to the drill operating in the clockwise direction.

10. The hole saw plug removal assembly of claim 9, wherein:
the pins are configured to align with a plurality of openings through a surface of the hole saw; and
in response to the drill operating in a counterclockwise direction, the pins are configured to pass through the plurality of openings.

11. The hole saw plug removal assembly of claim 8, further comprising a lock disposed on the device body, the lock comprising a locked configuration and an unlocked configuration, and
wherein:
the lock is operably coupled to the at least two pins;
the unlocked configuration allows for a first amount of translational movement of the at least two pins during operation of the drill; and
the locked configuration allows for a second amount of translational movement of the at least two pins during operation of the drill, the second amount being less than the first amount.

12. The hole saw plug removal assembly of claim 11, wherein the actuator comprises:
a rod configured to extend through the drill end, the rod being operably coupleable with the drill;
a first clutch piece configured to receive the rod;
a second clutch piece configured to receive the rod, the second clutch piece being operably coupleable with the first clutch piece and operably coupled to the at least two pins; and
a guide bar configured to guide the movement of the first clutch piece and the second clutch piece, and wherein:
movement of the lock from the locked configuration to the unlocked configuration causes the first clutch piece to uncouple from the second clutch piece; and
the first clutch piece is configured to travel along the guide bar.

13. A method for removing a hole saw plug, comprising:
providing an assembly for removing a hole saw plug, the assembly comprising:
a drill;
a hole saw comprising a plurality of hole saw openings;
a hole saw plug removal device, comprising:
a device body, comprising:
a drill end configured operably coupled with the drill;
a hole saw end configured to operably couple with the hole saw;
a wall extending from the drill end to the hole saw end and forming a cavity;
an actuator disposed within the cavity and operably coupleable to the drill;
at least two pins comprising:
a first end operably coupled to the actuator; and
a second end; and
operating the drill in a counterclockwise direction such that the at least two pins move translationally through the hole saw openings, thereby applying a force on a plug such that the plug is removable from the hole saw.

14. The method of claim 13, further comprising operating the drill in a clockwise direction such that the pins retract toward the cavity.

15. The method of claim 13, wherein the hole saw plug removal device further comprises a lock disposed on the device body, the lock comprising a locked configuration and an unlocked configuration, and wherein:
the lock is operably coupled to the at least two pins;
the unlocked configuration allows for a first amount of translational movement of the at least two pins during operation of the drill; and
the locked configuration allows for a second amount of translational movement of the at least two pins during operation of the drill, the second amount being less than the first amount; and
the method further comprises:
unlocking the lock prior to operating the drill in a counterclockwise direction, thereby allowing the at least two pins to move the first amount of translational movement during operation of the drill.

16. The method of claim 15, further comprising:
unlocking the lock; and
after unlocking the lock, operating the drill in a clockwise direction such that the pins retract toward the cavity.

17. The method of claim 15, further comprising:
locking the lock; and
after locking the lock, operating the hole saw in a clockwise direction.

18. The method of claim 13, further comprising immobilizing the device body during operation of the drill, thereby preventing actuation of the hole saw and causing the translational movement of the pins.

19. The method of claim 13, further comprising aligning the pins with the hole saw openings.
